(19) United States
(12) Patent Application Publication
(10) Pub. No.: US 2023/0400691 A1
(43) Pub. Date: Dec. 14, 2023

(54) LIGHT GUIDING PLATE, LIGHT GUIDING PLATE MODULE, AND IMAGE DISPLAY DEVICE

(71) Applicant: Hitachi-LG Data Storage, Inc., Tokyo (JP)

(72) Inventor: Hiroyuki MINEMURA, Tokyo (JP)

(21) Appl. No.: 18/033,386

(22) PCT Filed: Nov. 17, 2021
(86) PCT No.: PCT/JP2021/042310

§ 371 Date: Apr. 24, 2023

(30) Foreign Application Priority Data
Feb. 2, 2021 (JP) 2021-015366

(51) Int. Cl. G02B 27/01

(52) U.S. Cl. CPC G02B 27/0172; G02B 2027/0118

(57) ABSTRACT

A light guiding plate comprising: a substrate; an incidence diffraction grating for diffracting incident light; and an emission diffraction grating for emitting, from the substrate, light diffracted by the incidence diffraction grating. The emission diffraction grating has a mesh-like grating pattern formed on the substrate. The mesh-like grating pattern is formed from a first parallel straight line group and a second parallel straight line group intersecting the first parallel straight line group. The pitch of the first parallel straight line group and the pitch of the second parallel straight line group are equal. Between the incidence diffraction grating and the mesh-like grating pattern, a line region is provided that consists only of the first parallel straight line group or the second parallel straight line group.

### TECHNICAL FIELD

The present invention relates to a light guiding plate, a light guiding plate module, and an image display device.

### BACKGROUND ART

In an image display device of augmented reality, it is possible to view not only an image projected by a user but also the surroundings at the same time. The projected image may overlay the real world perceived by the user. Other applications for these displays include a video game, a wearable device such as eyeglasses, etc. The user can visually recognize an image superimposed on the real world and supplied from a projector by wearing an image display device in the form of glasses or goggles in which a translucent light guiding plate and the projector are integrated with each other. Such an image display device is described in each of “Patent Document 1” to “Patent Document 4”.

An image display device described in “Patent Document 1” is an image display device for expanding input light in two dimensions and has three linear diffraction gratings. One of the linear diffraction gratings is a diffraction grating for incidence, and the other two diffraction gratings for emission are typically disposed on a front surface and a back surface of a light guiding plate so as to overlap each other, and perform functions of diffraction gratings for duplication and output. Further, “Patent Document 1” describes an example in which a diffraction grating for emission is formed on one surface by a cylindrical photonic crystal-type periodic structure.

With regard to an image display device described in “Patent Document 2”, technology for constructing an optical structure by a plurality of linear side surfaces is disclosed in order to solve a problem of “Patent Document 1” in that an image projected by photonic crystal has high luminance in a central part of a field of view.

“Patent Document 3” discloses a light guiding plate using a member made of resin in order to reduce cost and weight due to use of a light guiding plate made of glass.

“Patent Document 4” discloses a light guiding plate having an intermediate diffraction grating in an optical path from an incidence diffraction grating to an emission diffraction grating in order to improve luminance of an image perceived by a user and enhance visibility.

### CITATION LIST

### Patent Document

Patent Document 1: JP 2017-528739 A

Patent Document 2: WO 2018/178626 A1

Patent Document 3: JP 2020-8599 A

Patent Document 4: JP 2020-79904 A

### SUMMARY OF THE INVENTION

### Problems to be Solved by the Invention

In a light guiding plate, light rays are duplicated and emitted by spreading out spatially. Therefore, as spatial spread increases, light rays visually recognized by a user decrease, and perceived luminance decreases. Meanwhile, an emission position perceived by the user changes according to a pixel position of original image information. Therefore, it is inevitable that luminance changes according to a pixel position in an image display device using the light guiding plate.

Accordingly, an object of the present invention is to suppress changes in luminance according to a pixel position of image information visually recognized by the user.

### Solutions to Problems

A preferable aspect of the invention is a light guiding plate including a substrate, an incidence diffraction grating configured to diffract incident light, and an emission diffraction grating configured to emit light diffracted by the incidence diffraction grating from the substrate, in which the emission diffraction grating includes a mesh-like grating pattern formed on the substrate, the mesh-like grating pattern includes a first parallel straight line group and a second parallel straight line group intersecting the first parallel straight line group, and a pitch of the first parallel straight line group is equal to a pitch of the second parallel straight line group, and a line region including only the first parallel straight line group or the second parallel straight line group is provided between the incidence diffraction grating and the mesh-like grating pattern.

Another preferable aspect of the invention is a light guiding plate module configured by stacking a plurality of light guiding plates, each of which is the light guiding plate.

Still another preferable aspect of the invention is an image display device including the light guiding plate module, and a projector configured to apply image light to the light guiding plate module, in which the image light is incident on the incidence diffraction grating.

### Effects of the Invention

It is possible to suppress changes in luminance according to a pixel position of image information visually recognized by a user.

### BRIEF DESCRIPTION OF THE DRAWINGS

FIG. 1A is a schematic cross-sectional view of a diffraction grating.

FIG. 1B is a schematic cross-sectional view of a thin film coating formed on a diffraction grating.

FIG. 2 is a graph illustrating examples of a phase function of an emission diffraction grating.

FIG. 3 is a perspective view illustrating a mesh-type diffraction grating of an embodiment.

FIG. 4 is a graph of a simulation result indicating a relationship between an aspect ratio and display performance.

FIG. 5 is a graph of simulation results illustrating a relationship between a cross-sectional shape and diffraction efficiency.

FIG. 6 is a conceptual diagram illustrating a definition of an emission circle.

FIG. 7 is a distribution diagram illustrating a simulation result of an intensity distribution of light ray propagating inside a light guiding plate.

FIG. 8 is a schematic view illustrating a light guiding plate of an embodiment.

FIG. 9 is a schematic view illustrating a relationship between a diffraction grating of the light guiding plate and a wavevector.

FIG. 10 is an explanatory diagram illustrating a simulation result of a projected image.

FIG. 11 is an explanatory diagram illustrating a simulation result illustrating a diffracted light ray of an incidence diffraction grating.

FIG. 12A is a schematic view of an example in which a projector and a user are disposed on the same side with respect to the light guiding plate.

FIG. 12B is a schematic view of an example in which the projector and the user are disposed on the opposite side from the light guiding plate.

FIG. 13 is a schematic cross-sectional view illustrating a method of forming the light guiding plate of an embodiment.

FIG. 14A is an image diagram of an AFM observation result of an emission diffraction grating of the light guiding plate.

FIG. 14B is an image diagram of an AFM observation result of the emission diffraction grating of the light guiding plate.

FIG. 15 is a schematic view illustrating a diffraction grating pattern of the light guiding plate of an embodiment.

FIG. 16A is a schematic view illustrating another diffraction grating pattern of the light guiding plate of an embodiment.

FIG. 16B is a schematic view illustrating another diffraction grating pattern of the light guiding plate of an embodiment.

FIG. 16C is a schematic view illustrating another diffraction grating pattern of the light guiding plate of an embodiment.

FIG. 17 is a schematic view illustrating a path of an image light ray inside the light guiding plate of an embodiment.

FIG. 18 is a graph illustrating a calculation result of a propagation pitch TP.

FIG. 19A is a schematic view of the light guiding plate.

FIG. 19B is an enlarged view of a central portion 1900 of the light guiding plate and is a schematic view of an ideal case.

FIG. 19C is an enlarged view of the central portion 1900 of the light guiding plate and is a schematic view in which line patterns are formed out of phase.

FIG. 19D is an enlarged view of the central portion 1900 of the light guiding plate and is a schematic view of the case where a gap of a length δ is provided at a boundary of two line patterns.

FIG. 20 is a schematic view for describing a diffraction direction of the diffraction grating of an embodiment.

FIG. 21 is a schematic view illustrating a configuration of an image display device of an embodiment.

### MODE FOR CARRYING OUT THE INVENTION

Some features described in embodiments will be described. In the following embodiments, a light guiding plate having a concave-convex diffraction grating will be described as a light guiding plate. In addition, to facilitate understanding, inversion of an image due to an action of a lens of an eye and an effect of processing an image projected on a retina by a brain and further inverting and perceiving the image will be omitted, and a relationship between a pixel position and luminance will be discussed with regard to a projected image projected on a screen ahead from an image light source disposed on the same side as eyes with respect to the light guiding plate. An actually visually recognized image is vertically inverted with respect to this image.

Moreover, in the embodiments, a plastic light guiding plate is adopted from a viewpoint of safety, weight reduction, and cost reduction. When compared to a conventional glass light guiding plate, the plastic light guiding plate has smaller mechanical strength (Young's modulus), and thus is more susceptible to deformation due to environmental temperature and atmospheric pressure. In order to reduce an influence of deformation, it is effective to adopt a transmission-type optical configuration in which an image source and a user are positioned on opposite sides with the light guiding plate interposed therebetween. In this case, transmission diffraction is used to diffract image light from the light guiding plate toward eyes of the user. In general, since transmission diffraction efficiency is smaller than reflection diffraction efficiency, luminance of image information visually recognized by the user is lower than that of the glass light guiding plate. Therefore, it is desirable to improve the luminance by improving the diffraction efficiency.

In this specification, the term “plastic” means a material including a polymer compound, and has a concept that does not include glass, and includes resin, polycarbonate, acrylic resin, photocurable resin, etc.

By forming a thin film coating on an emission diffraction grating by a sputtering method, etc., it becomes possible to improve diffraction efficiency in a direction of the eyes of the user, and thus luminance is improved. An upper limit of diffraction efficiency of a concave-convex pattern formed on a surface of the plastic light guiding plate is mainly determined by a wavelength of a light source, a pattern height, and a refractive index of a plastic material, and is about 4% at maximum. This value can be improved by about two times by forming a thin film coating layer using a dielectric material on the emission diffraction grating.

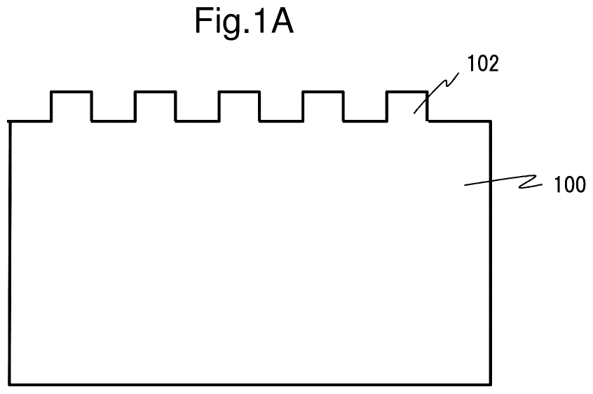

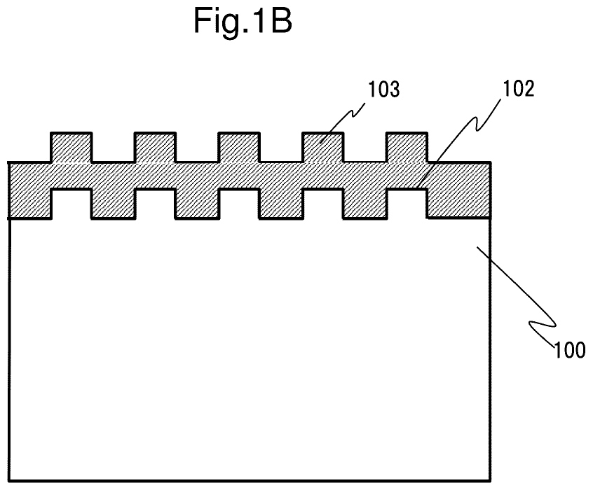

FIGS. 1A and 1B are schematic views for describing improvement of diffraction efficiency of the emission diffraction grating by the thin film coating.

FIG. 1A is a schematic view of a cross section of a plastic light guiding plate. A light guiding plate 100 is made of a plastic material, and an emission diffraction grating 102 is formed as a concave-convex pattern on a surface. When plastic molding technology such as injection molding is used, these parts are formed from the same material as integral molding. However, in plastic molding technology such as an injection molding method, an aspect ratio (height/width) of a concave-convex pattern of an emission diffraction grating is preferably about 1 or less.

When the aspect ratio of the concave-convex pattern exceeds 1, accuracy of pattern transfer of a surface concave-convex pattern formed by injection molding technology, etc., which has a proven track record as a manufacturing method for optical disc media, is degraded. A reason therefor is that melted polycarbonate resin, acrylic resin, polyolefin resin, etc. have high viscosity, and resin cannot accurately enter into the high-aspect-ratio concavities and convexities formed at nanometer intervals.

FIG. 1B is a schematic view illustrating the case where a coating layer 103 of a dielectric film is formed on a surface of the emission diffraction grating 102 of FIG. 1A by sputtering, etc. A concave-convex pattern of a dielectric material is formed on the surface, reflecting concavities and convexities of the original grating pattern. At this time, when a refractive index of the used dielectric material is set to be higher than a refractive index of a plastic material, the phase modulation amount increases reflecting a refractive index difference between the dielectric material and air. A reason therefor is that the phase modulation amount of the emission diffraction grating with respect to incident light is influenced by a difference between the refractive index of the plastic material in convex portions and the refractive index of the air in concave portions. Therefore, even when the aspect ratio of the concave-convex pattern is 1 or less, high diffraction efficiency can be obtained.

Specifically, it is necessary to determine a film thickness of the dielectric material so that predetermined diffraction efficiency is obtained by performing electromagnetic field analysis using an FDTD (Finite Differential Time Domain) method, etc. An effect of increasing the diffraction efficiency can be obtained when the film thickness of the dielectric material to be formed is about 10 nm to 200 nm.

Further, a photonic crystal and a diffraction grating disclosed in Patent Document 1 spatially modulate a phase of incident light by surface concavities and convexities. The magnitude of phase modulation increases in proportion to a difference in refractive index between a surface structure and air and a height of the surface concavities and convexities.

When a cylindrical photonic crystal is formed on a surface of a light guiding plate by an injection molding method, etc., a refractive index of a cylinder becomes equal to that of a waveguide (or substrate). In this case, when an aspect ratio, which is a ratio of a diameter to a height of the cylinder, is not greater than about 2, luminance of a projected image is insufficient. When the photonic crystal of Patent Document 1 is used without change on a plastic substrate, the aspect ratio of the concave-convex pattern transferred to the surface of the light guiding plate is large, and formation is difficult using plastic molding technology having a proven track record such as the injection molding method.

In the present embodiment, a diffraction grating of a two-dimensional mesh-like pattern is used as the emission diffraction grating 102. In this way, it is possible to reduce the aspect ratio of the concave-convex pattern transferred to the surface of the light guiding plate, and to provide the light guiding plate using plastic molding technology having a proven track record such as the injection molding method. In the present embodiment, the description will proceed with a coordinate system in which an optical axis is taken as a Z-axis, and an XY-plane is taken as the surface of the light guiding plate.

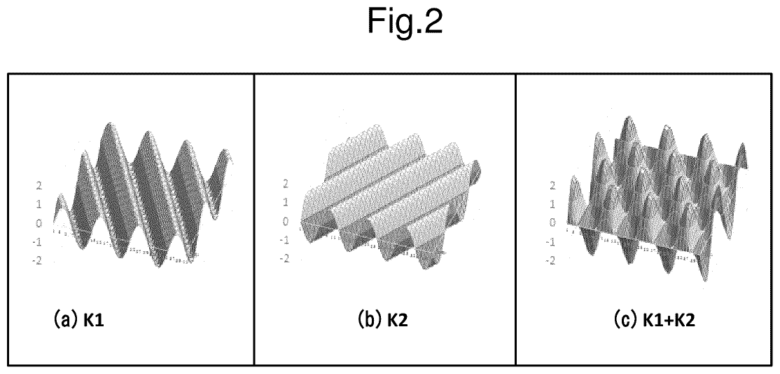

FIG. 2 schematically illustrates wavenumbers of emission diffraction gratings. Phase functions of diffraction gratings having wavenumbers K1 and K2 with azimuth angles of ±60 degrees with respect to a Y axis are illustrated in FIGS. 2(a) and 2(b), respectively, and each has a sinusoidal phase distribution. The phase modulation amount is normalized to 1. FIG. 2(c) is obtained when these phase functions are synthesized, and it can be considered that the photonic crystal shown in Patent Document 1 is formed on the surface of the light guiding plate using a material having a high refractive index by approximating this function to a pillar (cylinder), etc. As can be seen in the figure, a maximum value of the phase modulation amount of K1+K2 is 2, and it can be seen that, when this is approximated by an isolated cylinder, etc. disclosed in Patent Document 1, twice the height (aspect ratio) is required when compared to single sinusoidal diffraction gratings of FIGS. 2(a) and 2(b).

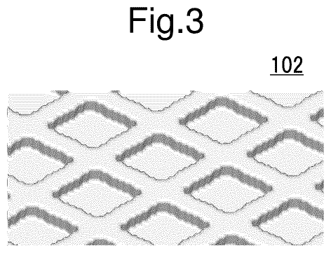

FIG. 3 is a perspective view of the mesh-type emission diffraction grating 102 employed in the embodiment. When compared to FIG. 2(c), since a sinusoidal structure is not taken, a higher-order wavenumber component is obtained through Fourier transformation. However, when used as the light guiding plate, by appropriately selecting a period, second-order and higher-order wavenumber components can be made non-diffractive (the wavenumber is an imaginary number) with respect to incident light. In addition, the mesh-like diffraction grating is a stack of ±60-degree rectangular diffraction gratings, and does not have wavenumber components other than directions of fundamental waves K1 and K2 when compared to a cylinder, etc., so that diffraction efficiency can be increased.

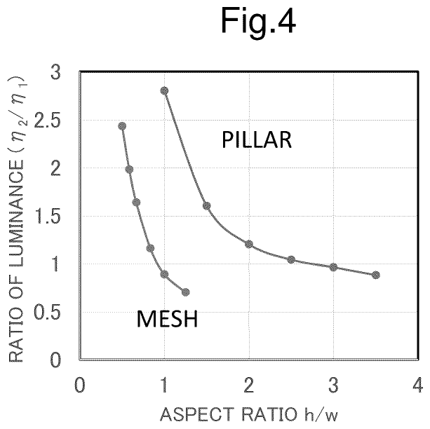

FIG. 4 illustrates wave calculation results indicating a relationship between an aspect ratio (height h/width w) and a luminance ratio of a central portion and a peripheral portion of a projected image of concave-convex patterns of the mesh-type emission diffraction grating and the pillar-type emission diffraction grating described in “Patent Document 1” in the case of using diffraction gratings made by injection molding using the same substrate material. As the luminance ratio of the central portion and the peripheral portion of the projected image approaches 1, the luminance is more uniform, visibility is more excellent, and quality is higher.

As can be seen in FIG. 4, the mesh type satisfies this condition with a smaller aspect ratio (for example, 1 or less). On the other hand, when the light guiding plate is made of plastic by the injection molding method, etc., it is preferable that the aspect ratio of the pattern is smaller considering the process margin, lot variation, etc. Furthermore, it is strongly desired that there be a method for making quality of a projected image constant with respect to variations in the aspect ratio of the diffraction grating due to lot variations.

As for the incidence diffraction grating of the embodiment, by using a reflection-type diffraction grating instead of a transmission diffraction grating, a low aspect ratio is realized by utilizing reflection, which has a large deflection action on refraction.

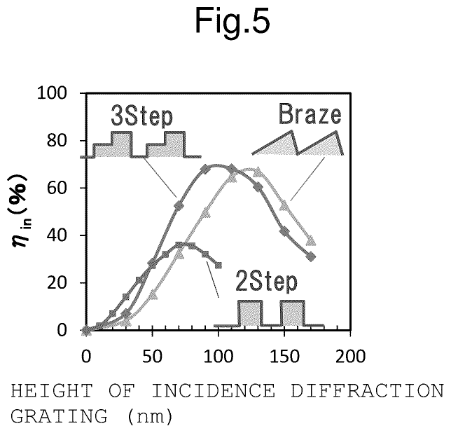

FIG. 5 illustrates wave calculation results indicating a relationship between an incidence diffraction grating height and diffraction efficiency. FIG. 5 also illustrates cross-sectional shapes of diffraction gratings. Here, the results are obtained when an interference film having a wavelength separation function is formed on a concave-convex pattern of a diffraction grating by alternately stacking five layers using ZnS—SiO₂ (20%) and SiO₂ materials.

In general, it has been known that diffraction efficiency of a blaze type diffraction grating is higher than that of a 2-step type diffraction grating. However, as illustrated in the figure, equivalent diffraction efficiency can be obtained by a 3-step type diffraction grating. It is possible to form a concave-convex pattern on a Si substrate by electron beam lithography, produce a Ni stamper by electroforming using this pattern as a matrix, and produce a plastic light guiding plate by an injection molding method using the Ni stamper. At this time, the 3-step type incidence diffraction grating is more suitable than the blaze type for the Si matrix formed by the electron beam lithography method since the number of steps is smaller.

As a result, a two-dimensional emission diffraction grating having a reduced aspect ratio can be provided, which can be realized by plastic molding technology such as the injection molding method, and a safe and lightweight light guiding plate having high image luminance can be provided.

According to technology recommended in the embodiments, in a light guiding plate (image display element) having a surface concave-convex type diffraction grating, it is possible to form a thin film coating layer of a dielectric material, etc. on the surface of the emission diffraction grating by a sputtering method, etc., and to increase emission diffraction efficiency to 4% or more. When the mesh-type emission diffraction grating is used, the light guiding plate can be made of plastic by the injection molding method, etc., and a safe and lightweight light guiding plate having high luminance can be realized.

Furthermore, an example of improving image quality by extending a line of the emission diffraction grating between the incidence diffraction grating and the emission diffraction grating is presented as a countermeasure against a problem that the luminance in the central portion of the projected image is higher than that in the periphery, and it is possible to make the luminance ratio of the projected image uniform.

Hereinafter, embodiments of the invention will be described with reference to the drawings. However, the invention should not be construed as being limited to the description of the embodiments shown below. Those skilled in the art will easily understand that a specific configuration can be changed without departing from the idea or gist of the invention.

In the configuration of the invention described below, the same reference numerals may be used in common for the same parts or parts having similar functions between different drawings, and redundant description may be omitted.

When there is a plurality of elements having the same or similar functions, the elements may be described with the same reference numerals and different suffixes. However, when there is no need to distinguish between the plurality of elements, the suffixes may be omitted for description.

Notations such as “first”, “second”, “third” in this specification etc. are attached to identify components, and do not necessarily limit the number, order, or content thereof. In addition, numbers for identifying components are used for each context, and numbers used in one context do not necessarily indicate the same configuration in other contexts. In addition, a component identified by a certain number is not precluded from having a function of a component identified by another number.

A position, size, shape, range, etc. of each configuration illustrated in the drawings, etc. may not represent an actual position, size, shape, range, etc., in order to facilitate understanding of the invention. For this reason, the invention is not necessarily limited to positions, sizes, shapes, ranges, etc. disclosed in the drawings, etc.

Publications, patents, and patent applications cited in this specification are included in a part of description of this specification without change.

It is assumed that a component presented in a singular form in this specification includes a plural form unless the context clearly states otherwise.

In the present embodiment, the description will proceed with a coordinate system in which an optical axis is taken as a Z-axis, and an XY-plane is taken as the surface of the light guiding plate. In addition, when a pupil of a user is approximated to a circle, an emission position in the light guiding plate visually recognized by the user also becomes a circle according to a pixel position. Hereinafter, the circle is referred to as an emission circle.

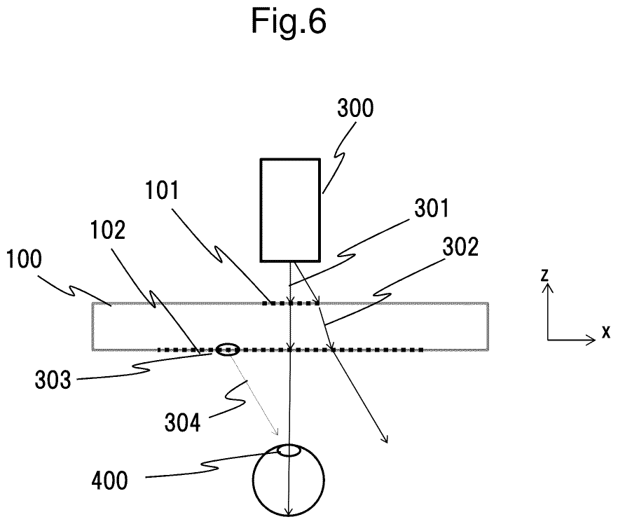

FIG. 6 is a schematic view for describing the emission circle. Here, the case where a projector 300, which is a light source for forming an image, and a pupil 400 of the user are disposed on opposite sides with respect to the light guiding plate 100 is illustrated. Assuming that a wavevector of the incidence diffraction grating 101 is directed in a y-direction, arrows in the figure represent light rays in an xz-plane. It is assumed that the incidence diffraction grating 101 does not have a wavevector component in an x-direction.

A light ray emitted from the projector 300 is coupled to the light guiding plate 100 by the incidence diffraction grating 101 and propagates inside the light guiding plate 100 while being totally reflected. The light ray is totally reflected and propagates inside the light guiding plate 100 while being further converted into a plurality of light rays duplicated by the emission diffraction grating 102, and is finally emitted from the light guiding plate 100. Some of the emitted light rays are imaged on the retina through the pupil 400 of the user and recognized as an augmented reality image superimposed on an image of the real world.

In the light guiding plate 100 using such a concave-convex type diffraction grating, a wavevector K of a light ray emitted from the projector 300 is refracted in the light guiding plate 100 and the wavevector becomes K₀ according to Snell's law. Further, the incidence diffraction grating 101 performs conversion into a wavevector K₁ allowing total reflection and propagation inside the light guiding plate 100. Due to diffraction by the emission diffraction grating 102 provided on the light guiding plate 100, and the wavevector changes to K₂, K₃, . . . each time diffraction is repeated.

Assuming that a wavevector of a light ray finally emitted from the light guiding plate 100 is K′, |K′|=|K|, and when the projector 300 is located on the opposite side from the eye with the light guiding plate 100 interposed therebetween, K′=K. On the other hand, when the projector 300 is located on the same side as the eye with respect to the light guiding plate 100, the light guiding plate 100 acts in the same way as a reflecting mirror with respect to the wavevector, and when a normal vector of the light guiding plate 100 is set to a z-direction, and x, y, and z components of the wavevector are compared with one another, it is possible to obtain expressions Kx′=Kx, Ky′=Ky, and Kz′=−Kz.

A function of the light guiding plate 100 is to guide a light ray emitted from the projector 300 while duplicating the light ray into a plurality of light rays, and the plurality of emitted light rays is intended to be recognized by the user as image information equivalent to an original image. At this time, a duplicated light ray group spatially spread while having a wavevector equivalent to that of a light ray having image information emitted from the projector 300.

A part of the duplicated light ray group enters the pupil 400 of the user and is visually recognized by being imaged on the retina together with information of the external world, and it is possible to provide the user with information of augmented reality in addition to the information of the external world. A light ray carrying image information has a different wavevector depending on the wavelength thereof. Since the concave-convex type diffraction grating has a constant wavevector, the diffracted wavevector K differs depending on the wavelength of the incident light ray, and the light ray propagates through the light guiding plate at a different angle. The refractive index of the substrate included in the light guiding plate is substantially constant with respect to the wavelength, and a range of a condition for guiding light during total reflection varies depending on the wavelength of the incident light ray. For this reason, in order to allow the user to perceive an image with a wide viewing angle, it is necessary to stack a plurality of different light guiding plates for each wavelength. In general, it is considered appropriate that the number of light guiding plates is the number corresponding to each of R, G, and B, or about 2 to 4, which is ±1 thereof.

Of image light rays visually recognized by the user, a light ray 301 corresponding to a center of a visual field travels straight in the xz-plane and reaches the pupil 400 of the user as illustrated in the figure. Diffraction in the y-direction, which is a function of the light guiding plate 100, is not explicitly expressed. However, diffraction occurs at least once by each of the incidence diffraction grating 101 and the emission diffraction grating 102.

On the other hand, of the image light rays visually recognized by the user, a light ray 302 corresponding to the periphery of the visual field travels in a right direction in the figure when there is no diffraction in the x-direction. On the other hand, in order for the user to recognize this light ray as a projected image, it is necessary that a light ray at the same angle reaches the pupil 400 of the user through a path illustrated as a visually recognized light ray 304 in the figure.

An emission circle 303 is a virtual circle that is on the emission diffraction grating 102 and translated through the pupil 400 of the user in a direction of the visually recognized light ray. Only the light ray 304 emitted from the emission circle 303 on the emission diffraction grating 102 is recognized as a projected image by the user, and other light rays are not recognized. In this way, the emission diffraction grating 102 requires diffraction action in the x-direction.

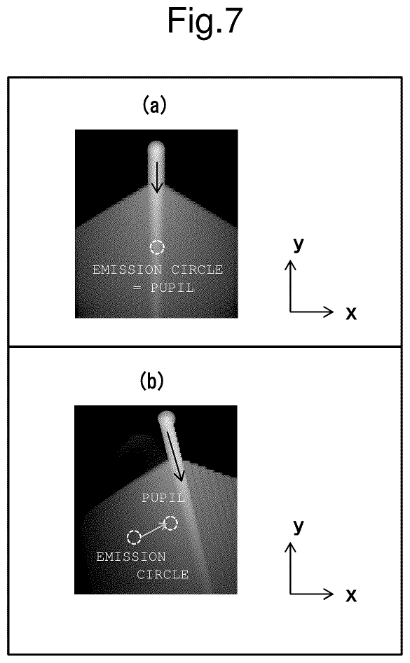

FIG. 7 illustrates an intensity distribution of light rays propagating inside the light guiding plate 100 calculated using a simulation method to be described later. It should be noted here that the intensity distribution is illustrated in an xy-plane within a surface including a diffraction grating of the light guiding plate. In the figure, the incidence diffraction grating is disposed on an upper side, and the pupil corresponding to the eye of the user is disposed below the incidence diffraction grating.

FIG. 7(a) illustrates the case where the pixel position is at a center of a projected image. An emission circle in the figure indicates a region in which a light ray reaching the pupil is finally diffracted on the emission diffraction grating. A region in which the luminance is high on a straight line extending in the y-direction from the incidence diffraction grating indicates a primary light ray group (hereinafter referred to as a main light ray group) diffracted by the incidence diffraction grating to propagate inside the light guiding plate. As can be seen in the figure, there is a characteristic in that the intensity is gradually attenuated by propagation of the main light ray group. A light ray group in which the luminance is low spreading around the main light ray group is a light ray group diffracted by the emission diffraction grating and deflected in a traveling direction within the xy-plane. Under this condition, since the projected rays are in the z-axis direction, it can be seen that the emission circle and the pupil coincide with each other within the xy-plane. Therefore, a part of the main light ray group having high intensity reaches the pupil and is recognized as an image.

FIG. 7(b) illustrates the case of a pixel position at an upper right corner of a projected image. As can be seen in the figure, a main light ray group travels downward and to the right from the incidence diffraction grating. A position of the pupil is constant. However, the emission circle is an emission position of a light ray group traveling upward and to the right toward the pupil, and thus is shifted downward and to the left with respect to the pupil in the xy-plane. In this case, since the emission circle is at a position away from the main light ray group, the light ray group that reaches the pupil and is recognized as an image has lower luminance than that in the above case. A main reason why luminance unevenness occurs when an image is projected using a light guiding plate has been described above.

When a grating pitch is set to P, the magnitude of the wavevector of the diffraction grating is expressed as K=2n/P. When expressed in a coordinate system in which an optical axis direction is taken as the z-axis, the wavevector of the incidence diffraction grating 101 is K₁=(0, −K, 0). The emission diffraction grating 102 has two wavevectors with an angle of 120 degrees, which are K₂=(+K/√3, K/2, 0), K₃=(−K/√3, K/2, 0). When a wavevector of a light ray incident on the light guiding plate 100 is set to kⁱ=(kⁱₓ, kⁱ_{y}, kⁱ_{z}), a wavevector of an emitted light ray is set to k^{o}=(k^{o}ₓ, k^{o}_{y}, k^{o}_{z}), and K₁, K₂, and K₃ are sequentially applied to kⁱ, k^{o}=kⁱ is obtained as below, and it can be seen that a light ray of the same wavevector as that of an incident light ray, that is, a light ray having the same image information is emitted.

k^{o}=kⁱ

k^{o}ₓ=kⁱₓ+0+(K/√3)−(K/√3)=kⁱₓ

k^{o}_{y}=kⁱ_{y}+K−(K/2)−(K/2)=kⁱ_{y}

k^{o}_{z}=kⁱ_{z}

Next, a simulation method for analyzing the image display element of the embodiment will be briefly described. A light ray tracing method proposed by G. H. Spencer et al. in 1962 [G. H. Spencer and M. B. T. K. Murty, “General Ray-Tracing Procedure”, J. Opt. Soc. Am. 52, p. 672 (1962).] is a method of calculating an image, etc., observed at a certain point by tracking a path by focusing on particle nature of light, and has been vigorously improved mainly in the field of computer graphics [16-18]. A Monte Carlo light ray tracing method [I. Powell “Ray Tracing through systems containing holographic optical elements”, Appl. Opt. 31, pp. 2259-2264 (1992).] based on a light ray tracing method is a method for preventing an exponential increase in the amount of computation by stochastically treating path separation due to diffraction, reflection, etc., and is suitable for simulating a light guiding plate on which diffraction and total reflection propagation are repeated. Even though the Monte Carlo light ray tracing method can faithfully reproduce reflection and refraction, it is essential to develop a suitable model for diffraction.

In a light guiding plate for a head-mounted display, a diffraction model corresponding to a wavelength range (approximately 400 to 700 nm) over the entire visible light range and an incident angle range corresponding to a viewing angle (approximately 40°) of a projected image is essential, and a commercially available simulator requires an enormous amount of computation. Here, an algorithm that reduces the amount of computation to 1/1000 or less is used by an algorithm that stops calculation of a light ray guided to a region that is not visually recognized in advance considering that a visually recognized light ray is a part of all light rays. The angular and wavelength dependence of the diffraction efficiency of the diffraction grating is based on a method in which results of calculation by the FDTD method are tabulated in advance and referenced.

### First Embodiment

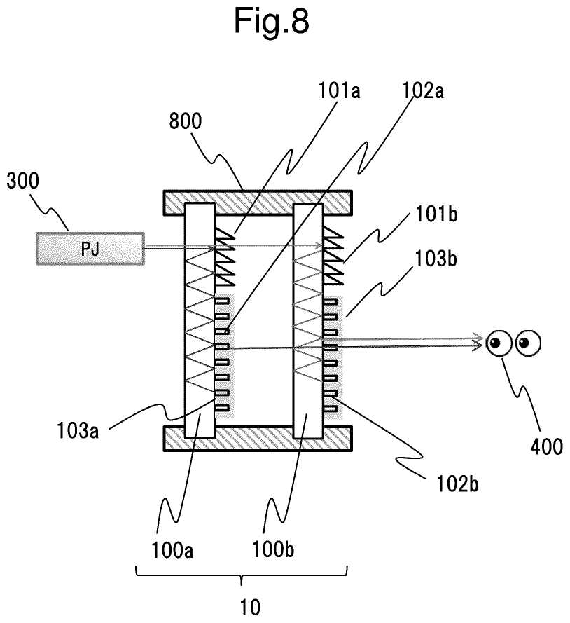

FIG. 8 illustrates a configuration of an image display element of an embodiment. Here, an image display element 10 includes two light guiding plates 100a and 100b held by a housing 800, and incidence diffraction gratings 101a and 101b and emission diffraction gratings 102a and 102b are formed thereon, respectively. The incidence diffraction gratings 101a and 101b are linear surface concave-convex type diffraction gratings. The emission diffraction gratings 102a and 102b have the same pattern periods as those of the incidence diffraction gratings 101a and 101b, respectively. Coating layers 103a and 103b are formed on surfaces of the emission diffraction grating 102a and 102b, respectively. The light guiding plates 100a and 100b have different pattern periods P1 and P2, respectively, and corresponding wavelength ranges are different from each other.

In the present embodiment, the emission diffraction gratings 102a and 102b are formed on the same surfaces as those of the incidence diffraction gratings 101a and 101b, respectively. However, the emission diffraction gratings 102a and 102b may be formed on opposite surfaces from surfaces of the incidence diffraction gratings 101a and 101b, respectively. With such a configuration, an image configuration emitted from the projector 300 can be visually recognized by the pupil 400 of the user. The projector 300 is disposed on the opposite side from the pupil 400 of the user with respect to the image display element 10.

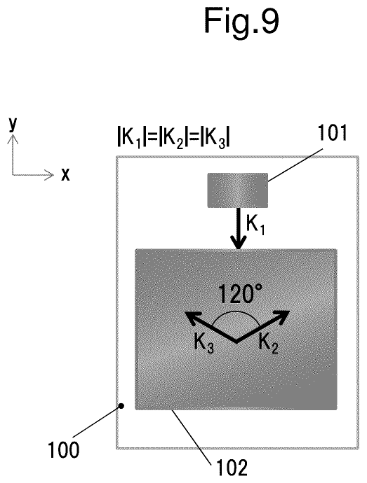

FIG. 9 illustrates an example of a relationship between wavevectors of the incidence diffraction grating 101 and the emission diffraction grating 102 formed on one light guiding plate 100. As described above, in order for the light guiding plate to function as the image display element, it is sufficient that the magnitudes of the wavenumbers K₁, K₂, and K₃ are equal to one another in the figure, and a relationship K₁+K₂+K₃=0 is satisfied.

First, the emission diffraction grating will be discussed. Projected images of a photonic crystal and a mesh-type diffraction grating in the case of the same aspect ratio of 0.8 are compared.

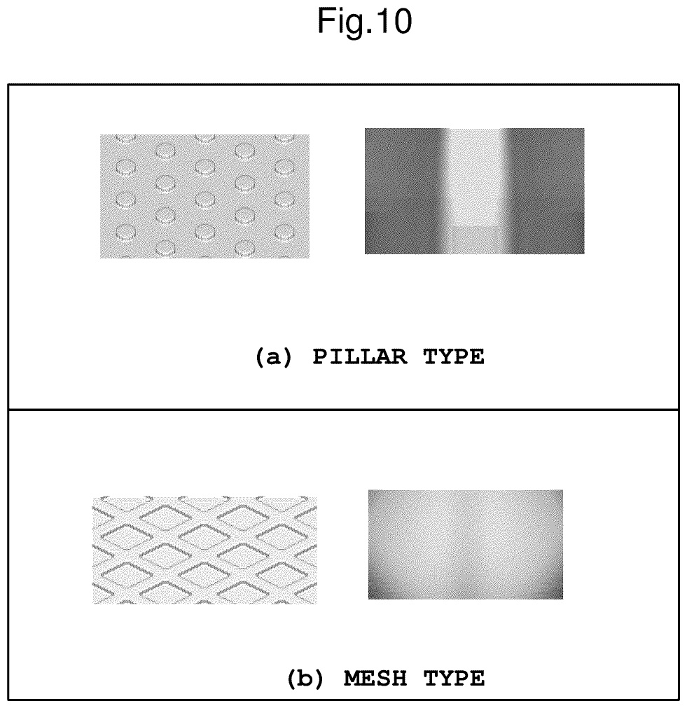

FIG. 10(a) is a simulation result of a pillar-type photonic crystal described in “Patent Document 1” and a projected image thereof. FIG. 10(b) is a result of a mesh-type diffraction grating of the embodiment. As can be seen from the figure, it can be understood that, when an aspect ratio is 1 or less, in the pillar-type photonic crystal, the luminance is high and visibility is poor at a central portion of a projected image. In comparison, the mesh-type diffraction grating of the present embodiment can obtain an excellent projected image with a low aspect ratio pattern.

Next, the incidence diffraction grating will be discussed.

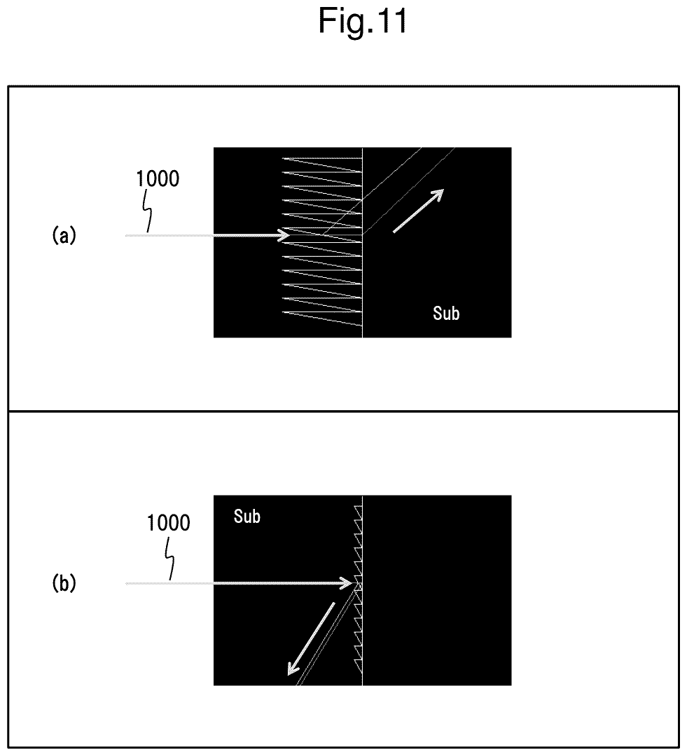

FIG. 11(a) illustrates a simulation result of a transmission-type diffraction grating. In the transmission-type diffraction grating, incident light is transmitted and diffracted and propagates inside the light guiding plate (substrate). A position of the incidence diffraction grating is formed on a surface of the light guiding plate close to a light source.

An image light ray 1000 is configured to enter from the left, and a right half of the figure represents the substrate (Sub). In the transmission-type diffraction grating, maximum diffraction efficiency is obtained under a condition that refraction by a blaze surface and diffraction by a periodic structure are phase-tuned. As illustrated in the figure, in order to achieve this, a height of the concave-convex pattern needs to be large, an angle of the pattern needs to be between and 80 degrees, and an aspect ratio obtained by dividing the height of the pattern by the period needs to be 10 or more. In a general plastic molding method such as injection molding, when the aspect ratio exceeds 1, a problem such as deterioration of transferability occurs, and a yield in mass production decreases. It can be seen that the transmission-type diffraction grating illustrated here is not suitable as an incidence diffraction grating employing a plastic substrate and injection molding.

FIG. 11(b) is a simulation result of a reflection-type diffraction grating. In the reflection-type diffraction grating, incident light is reflected and diffracted, that is, reflected to the light source side and propagates inside the light guiding plate (substrate). A position of the incidence diffraction grating is formed on a surface of the light guiding plate far from the light source.

An image light ray is similarly configured to enter from the left, and a left half of the figure represents the substrate (Sub). In the reflection-type diffraction grating, maximum diffraction efficiency is obtained under a condition that refraction by a blaze surface and diffraction by a periodic structure are phase-tuned. As illustrated in the figure, it can be seen that this condition is satisfied with the concavo-convex pattern having a low aspect ratio when compared to the transmission type. At this time, the concave-convex pattern has a height of about 250 nm and an aspect ratio of about 0.57. In the above-described prototype element, it is possible to satisfactorily transfer a triangular concave-convex pattern with a pattern height of 374 nm. It can be considered that the incidence diffraction grating suitable for the light guiding plate of the embodiment is the reflection-type incidence diffraction grating for plastic formation.

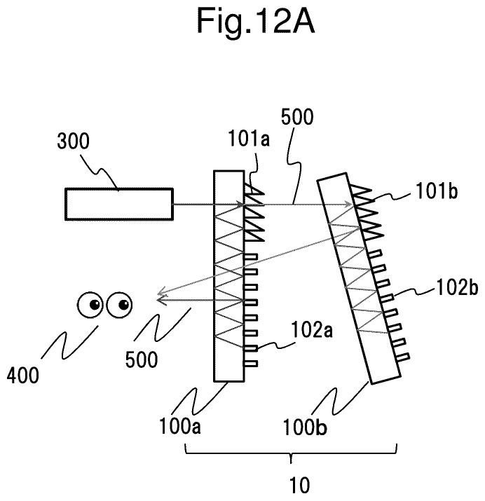

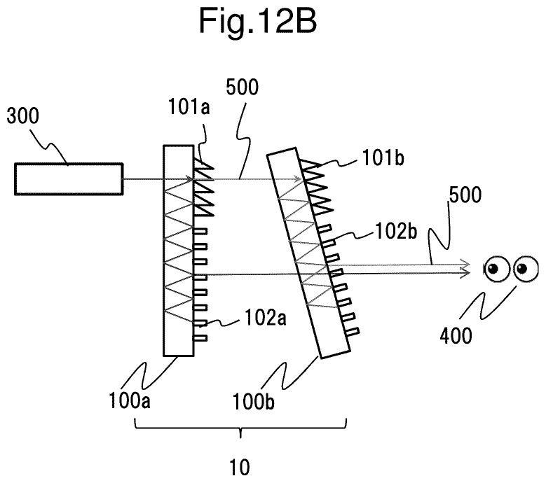

FIGS. 12A and 12B are schematic views illustrating effects of a relative tilt of two light guiding plates. A light guiding plate made of plastic is more likely to be deformed than a light guiding plate made of glass. In FIGS. 12A and 12B, the image display element 10 includes light guiding plates 100a and 100b with different corresponding wavelengths, respectively. In addition, reference numeral 300 is the projector for image projection, reference numeral 400 is the pupil of the user, and reference numeral 500 is a projected image light ray.

In this example, the reflection-type diffraction grating is adopted as the incidence diffraction grating based on the findings of FIG. 11. Therefore, the incidence diffraction grating 101 is formed on a surface of the light guiding plate 100 far from the projector 300 (a right surface in the figure). For convenience of the process, the emission diffraction grating 102 is similarly formed on the surface far from the projector 300 since accuracy can be increased when the emission diffraction grating 102 is formed on the same surface as that of the incidence diffraction grating 101.

FIG. 12A illustrates the case where the projector 300 and the pupil 400 of the user are disposed on the same side with respect to the light guiding plate 100. As illustrated in the figure, the light guiding plate 100 ultimately reflects the image light ray 500 to the user. For this reason, when the light guiding plate 100b is tilted compared to the light guiding plate 100a, the position of the pixel to be visually recognized shifts depending on the wavelength of the projected light ray, resulting in deterioration of the image quality. Since resolving power of a light ray angle of a user having visual acuity of 1.0 is 1/60 degrees, the relative tilt of the two light guiding plates needs to be sufficiently smaller than 1/60 degrees based thereon. The plastic light guiding plate, which has lower mechanical strength (Young's modulus) than a conventional glass plate, is difficult to mount as a head-mounted display. In this case, as the reflection diffraction efficiency of the emission diffraction grating increases, image information having higher luminance can be provided to the user.

FIG. 12B illustrates the case where the projector 300 and the pupil 400 of the user are disposed on the opposite sides with respect to the light guiding plate 100. As illustrated in the figure, the light guiding plate 100 ultimately transmits and delivers the image light ray 500 to the user. Since angles of incident light and emitted light are basically the same, even when there is a relative tilt between the light guiding plates 100a and 100b, a projected image is not shifted due to a wavelength in principle. Therefore, when the plastic light guiding plate of the present embodiment is mounted as a head-mounted display, it is desirable that the projector light source is on the opposite side from the user with respect to the light guiding plate (transmission-type optical configuration).

It should be noted that the relative tilt between the light guiding plates 100a and 100b is preferably suppressed to about 3 degrees or less since a light ray angle condition for total reflection and light guide inside the light guiding plate is actually affected. In this case, as the transmission diffraction efficiency of the emission diffraction grating increases, image information having higher luminance can be provided to the user.

Diffraction efficiency when light propagating through the light guiding plate is diffracted by the emission diffraction grating and emitted from the light guiding plate was calculated by the FDTD method. Under the condition that light corresponding to a central pixel of the projected image is coupled by incidence diffraction and propagates by total reflection inside the light guiding plate assuming that the wavelength is 550 nm, the refractive index of the light guiding plate is 1.58, the pattern period of the diffraction grating is 460 nm, the width of the convex portion is 150 nm, and the height of the convex portion is 70 nm, the reflection diffraction efficiency was 3.5%, and the transmission diffraction efficiency was 2.8%. The aspect ratio of the concave-convex pattern is 0.47. When the emission diffraction grating is formed on the same surface as that of the incidence diffraction grating as in FIG. 12B, the light ray visually recognized by the user is transmitted and diffracted by the emission diffraction grating. Therefore, in the transmission-type optical configuration illustrated in FIG. 12B, when compared to the reflection-type optical configuration of FIG. 12A, the luminance of the projected image visually recognized by the user is lowered. The problem of luminance reduction can be improved by adopting the above-described coating layer 103 or mesh-type diffraction grating.

FIG. 13 is a schematic view of a method of integrally molding diffraction gratings on both sides of the light guiding plate illustrated in FIG. 8 using plastic molding technology. Production of a conventionally used light guiding plate such as nanoimprinting or etching is surface processing technology based on semiconductor processing technology. Meanwhile, plastic molding technology such as the injection molding method is three-dimensional molding technology in which resin is introduced into a mold and solidified, and thus it is easy to form diffraction gratings on both sides of the light guiding plate. In the figure, stampers 700 and 701 provided on surfaces in the form of reversing the concavity and the convexity of the surface shape of the diffraction grating to be formed are fixed to a fixed portion 710 and a movable portion 720 of a mold, respectively. Using such a mold, when molten resin 740 is injected from a resin channel 730, and the movable portion 720 of the mold is moved in a right direction in the figure to apply pressure, it is possible to make the resin 740 into a shape along a shape of a cavity 750, and to produce a desired light guiding plate through a cooling process. This method is a general one, and by using two stampers, it is possible to produce a plastic light guiding plate having diffraction gratings on both surfaces formed in a concave-convex shape.

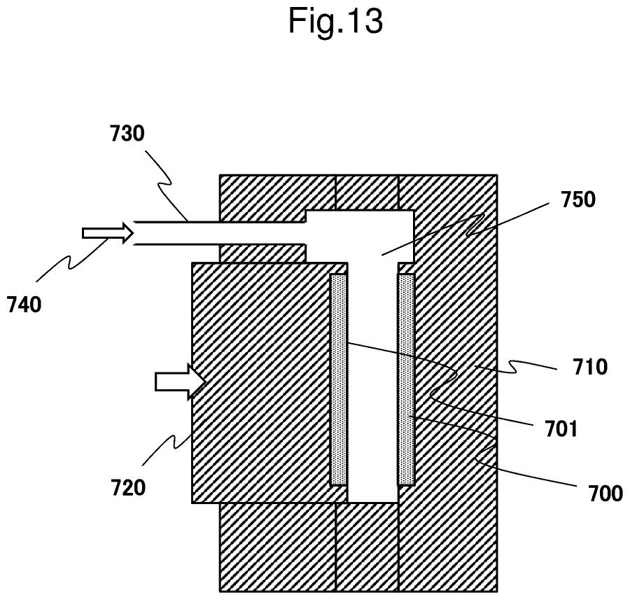

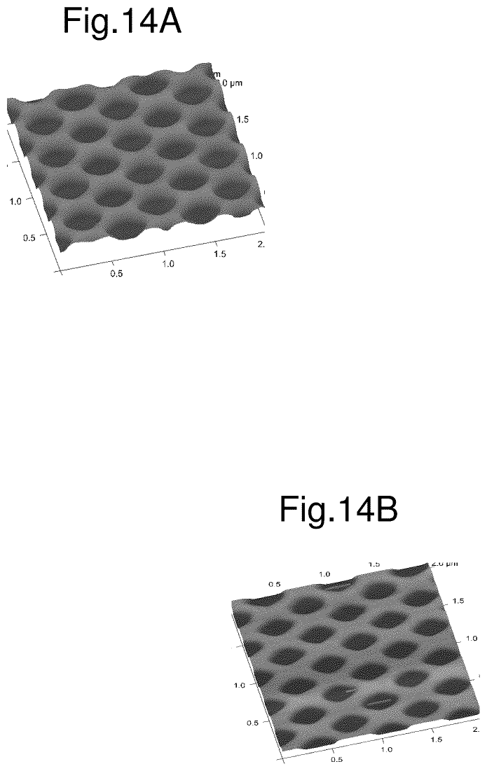

FIGS. 14A and 14B are AFM (Atomic Force Microscope) observation results of the emission diffraction grating of the light guiding plate produced by injection molding using the same resin material using the Ni stamper produced by the method described above. Both differ only in process conditions. As can be seen from the figure, it can be seen that transferability is better in FIG. 14B. As a result of carrying out an image projection test on these light guiding plates, the luminance ratio of the central portion and the peripheral portion of the projected image was 2.3 in the case of FIG. 14A and 1.03 in the case of FIG. 14B. Therefore, it can be seen that the quality of the projected image of the light guiding plate changes due to changes in process conditions, etc. From this result, it can be seen that, when variations in process conditions are unavoidable, variations in the luminance ratio of the central portion and the peripheral portion of the projected image cannot be avoided due to the lot.

FIG. 15 is a diffraction grating pattern for suppressing quality fluctuations of the projected image of the light guiding plate due to lot variations, etc. As illustrated in the figure, the diffraction grating of the light guiding plate of the embodiment includes the incidence diffraction grating 101 and the emission diffraction grating 102. The incidence diffraction grating 101 includes a linear grating in the x-direction, and the period (pitch) of the pattern is P. The incidence diffraction grating 101 is of a 3-step type.

As illustrated in FIG. 3, the emission diffraction grating 102 has a mesh region 1510 in which linear gratings having the same pattern period P as that of the incidence diffraction grating 101 intersect to form a mesh. An angle (acute angle) formed by each grating of the emission diffraction grating 102 and the x-axis is, for example, 60 degrees, which may be adjusted according to a size of the light guiding plate. In the following embodiment, description will be given on the assumption that the angle is 60 degrees. The period P of the pattern is, for example, 0.3 to 0.6 μm, which may be changed according to the wavelength of the light source or application.

A feature of the embodiment of FIG. 15 is that each of lines forming the mesh-type diffraction grating is extended above the emission diffraction grating 102 (on the side close to the incidence diffraction grating 101) to form a line region 1520, and lines on the right side and the left side in the figure do not intersect each other in the line region 1520.

Respective lines 1501 forming the line region 1520 are substantially symmetrical with respect to a line 1502 connecting the emission diffraction grating 102 and the incidence diffraction grating 101 on the xy-plane (main surface of the light guiding plate). The respective lines 1501 or extension lines thereof are substantially V-shaped with the line 1502 as a center when the incidence diffraction grating 101 is on top on the xy-plane. The line 1502 is generally a center line that bisects each of the emission diffraction grating 102 and the incidence diffraction grating 101.

In this way, when image light diffracted by the incidence diffraction grating 101 hits the line region 1520, the image light can be diffracted to the left or right in the figure. Since this has an effect of improving the luminance around the projected image, it is possible to reduce the pattern aspect ratio. Due to the wavenumber relationship described above, image light is not emitted from the line region 1520 toward the eye of the user. Therefore, the line region 1520 has a function of improving the luminance around a field of view and reducing the luminance at a center of the field of view.

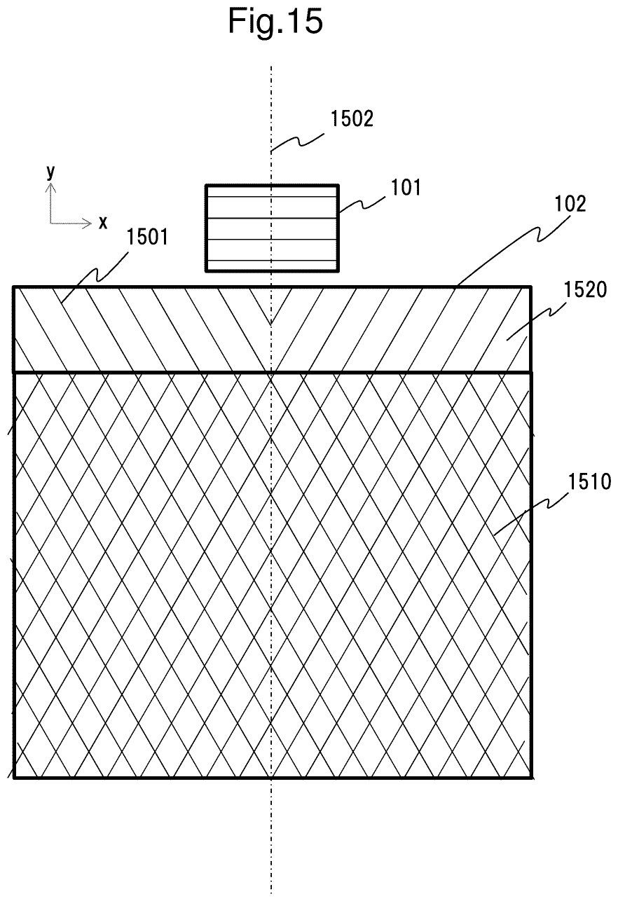

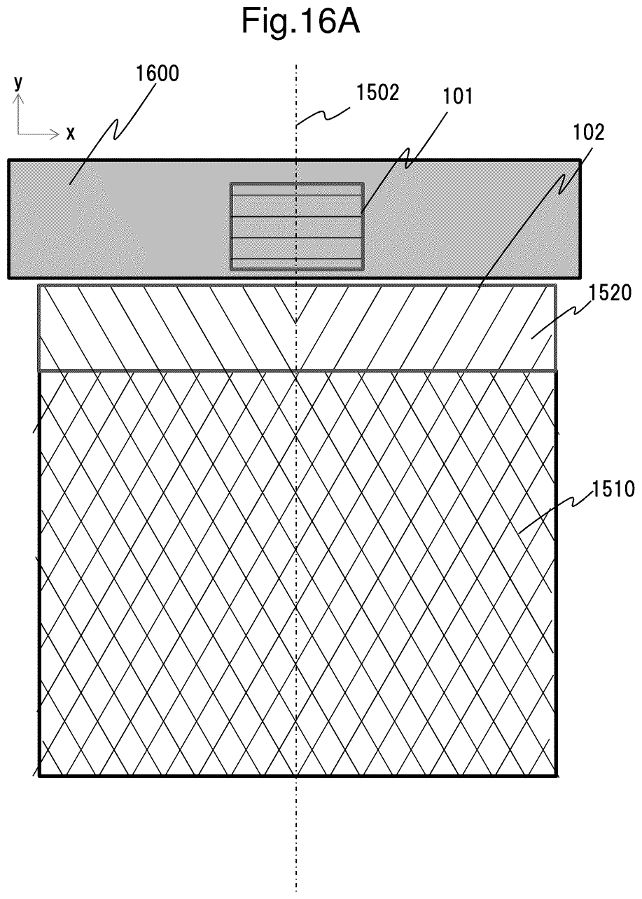

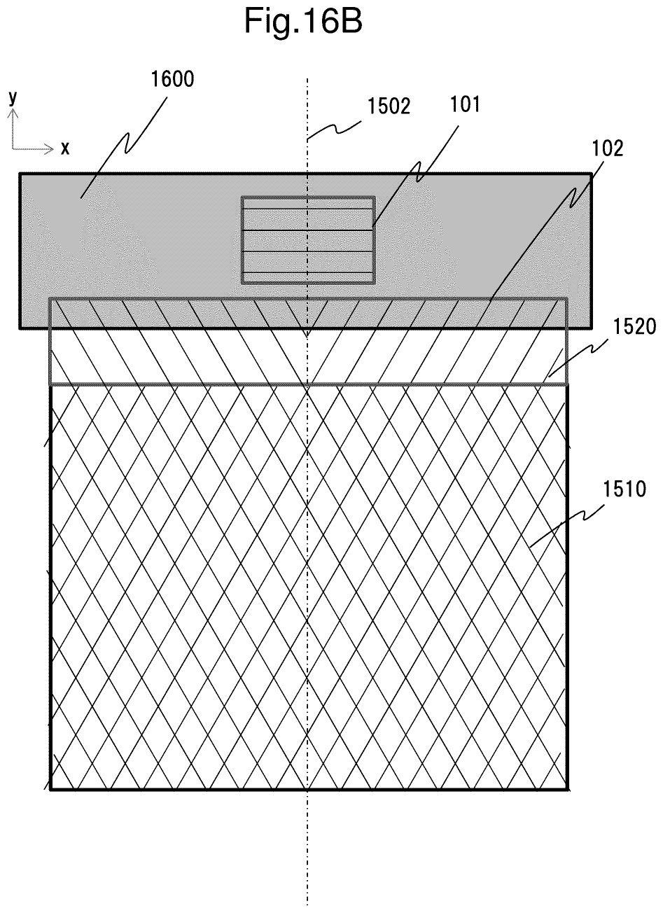

FIGS. 16A, 16B, and 16C are schematic views each illustrating a relationship between the diffraction grating pattern and a reflective coating applied to the incidence diffraction grating 101 for suppressing quality fluctuations in the projected image of the light guiding plate due to lot variations. A dielectric multilayer film can be used as the reflective coating 1600.

FIG. 16A corresponds to a standard situation, and the reflective coating 1600 is formed on the incidence diffraction grating 101.

FIG. 16B illustrates a countermeasure when the luminance ratio of the central portion and the peripheral portion of the projected image becomes larger than 1 due to lot variations. In this case, the size of the mask that forms the reflective coating 1600 is adjusted to form the reflective coating 1600 on a part of the line region 1520. Since the diffraction efficiency of the line region 1520 coated with the reflective coating 1600 is improved, the luminance around the field of view is improved, and the luminance in the central part of the field of view is reduced, so that the quality of the projected image can be improved.

FIG. 16C illustrates a countermeasure when the luminance ratio of the central portion and the peripheral portion of the projected image becomes larger due to lot variations. Similarly, the reflective coating 1600 is formed over most of the line region 1520 by adjusting the size of the mask used for mask sputtering, etc. As a result, an effect of improving the luminance around the field of view, and reducing the luminance in the central part of the field of view is enhanced, so that the quality of the projected image can be improved.

According to the above-described embodiment, after formation of the diffraction grating, it is possible to suppress luminance variations for each lot by adjusting a formation region of the reflective coating 1600.

As described above, it is possible to reduce the aspect ratio of the diffraction grating pattern of the light guiding plate of the embodiment formed by the injection molding method, etc., and to suppress the quality change of the projected image due to lot variations, etc.

### Second Embodiment

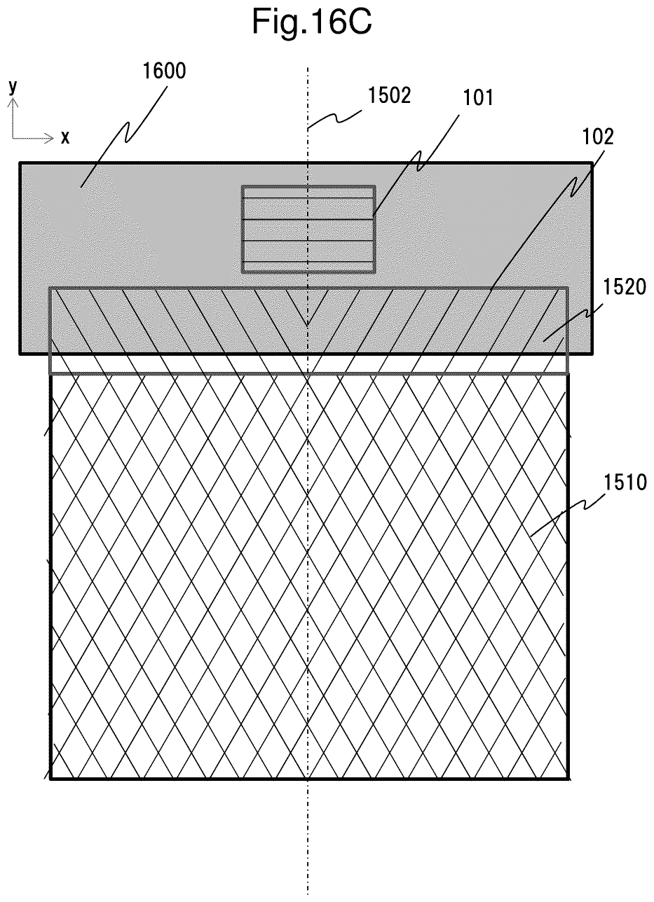

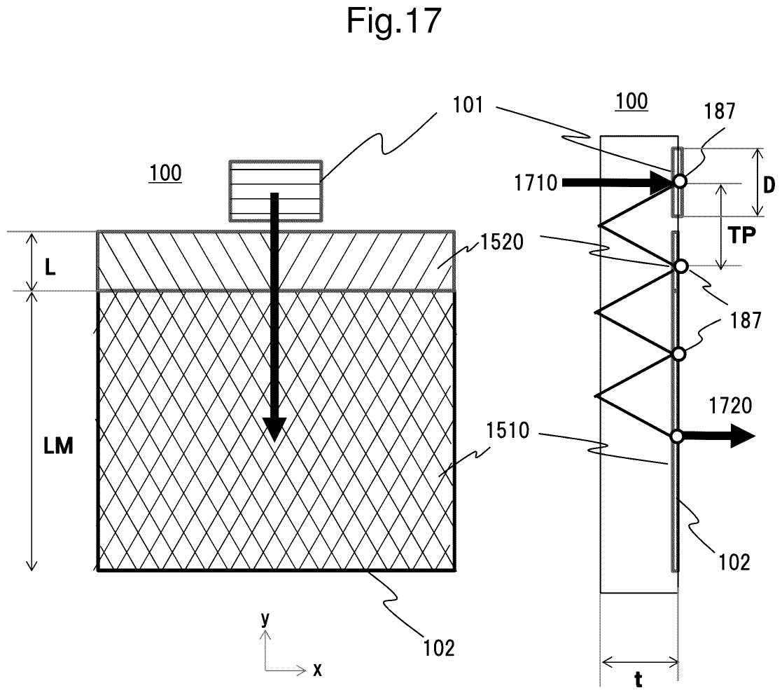

FIG. 17 a plan view and a side view schematically illustrating paths of image light rays inside the light guiding plate of the embodiment. An incident image light ray 1710 is diffracted by the incidence diffraction grating 101, propagates inside the light guiding plate 100 while being totally reflected and guided, passes through the line region 1520 of the emission diffraction grating 102, is emitted from the mesh region 1510 of the emission diffraction grating, and is visually recognized by the user (not illustrated) as emitted image light 1720.

In order for the embodiment to effectively function, at least a part of the image light ray 1710 needs to reach the line region 1520 during propagation.

When a length of the line region is set to L, and an interval between points 187 where the image light ray and the diffraction grating intersect each other (hereinafter referred to as a propagation pitch) is set to TP, as L increases, the number of intersections of the image light ray and the line region increases, and the effect of the embodiment is enhanced. When a criterion for a minimum value that L satisfies is defined as the case where light quantity of ½ of the image light ray intersects the line region 1520, the following relationship is obtained.

L>TP/2

Here, this relationship will be further described. The propagation pitch TP is determined by a wavelength λ of the image light ray, a pitch p of the diffraction grating, a thickness t of the light guiding plate, a refractive index n, and an incidence angle θy, and is expressed as below in the case of normal incidence.

TP=2t(2π/p+2nπ sin θ/λ)/{(2nπ/λ)²−(2π/p+2nπ sin θ/λ)²}^{0.5}

When the size D of the incidence diffraction grating 101 is larger than the propagation pitch TP, diffraction occurs a plurality of times inside the incidence diffraction grating 101, and emission occurs from the emission diffraction grating 102, leading to loss of light quantity. Thus, it is preferable that the size D of the incidence diffraction grating 101 is approximately the same as the propagation pitch TP (about 1 to mm). Similarly, a beam size of the image light ray 1710 is preferably approximately the same as the size D of the incidence diffraction grating 101. At this time, spread of positions of incident light can be considered as ±D/2≈±L/2 with respect to a center. Therefore, the image light ray diffracted by the incidence diffraction grating has positional spread of ±L/2 while propagating at the propagation pitch TP, and the above equation is obtained from a condition that ½ of the light quantity intersects the line region 1520.

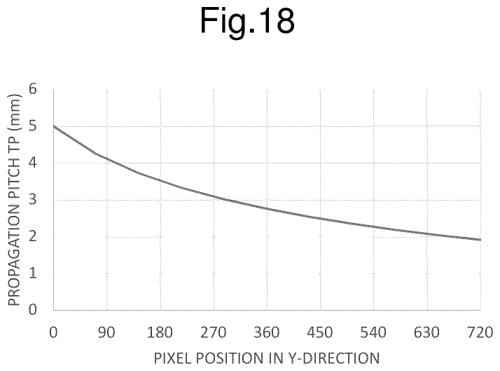

FIG. 18 illustrates a calculation result of the propagation pitch TP when the wavelength of the incident light is set to 460 nm, the pattern pitch of the incidence diffraction grating is set to 360 nm, the refractive index of the light guiding plate is set to 1.58, and the thickness t of the light guiding plate is set to 1 mm. In the figure, a horizontal axis represents a position of the image pixel in the Y-direction, and a result in the case of a diagonal viewing angle of 40 degrees and 720 pixels in the Y-direction is illustrated. A rough estimate of the propagation pitch TP is about 2.7 mm at normal incidence (pixel position 360), and ranges from about 2 mm to 5 mm depending on the pixel position. From the above relationship, it can be seen that the embodiment preferably functions when the length L of the line region is 1 mm or more.

The propagation pitch TP is proportional to the thickness t of the light guiding plate, and the minimum value of 2 mm of the propagation pitch is twice the thickness t of the light guiding plate. Thus, when the above relationship is generalized, L>t is obtained.

In addition, when the length L of the line region increases, the light guiding plate becomes large and heavy, which is a disadvantage for the user. Thus, considering the weight, it is preferable that a rough estimate of an upper limit of the length L of the line region is equal to or less than a length LM of the mesh region.

### Third Embodiment

A pattern formation method suitable for forming the line region 1520 of the emission diffraction grating of the embodiment is shown.

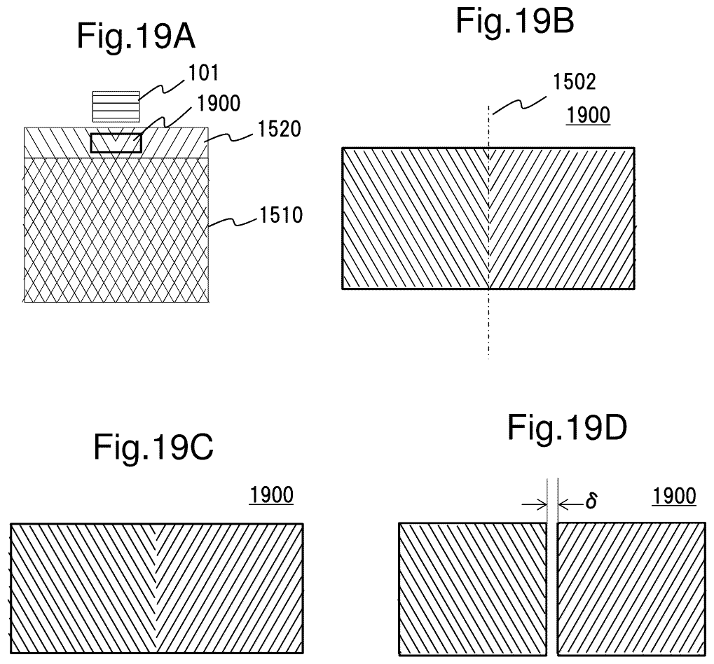

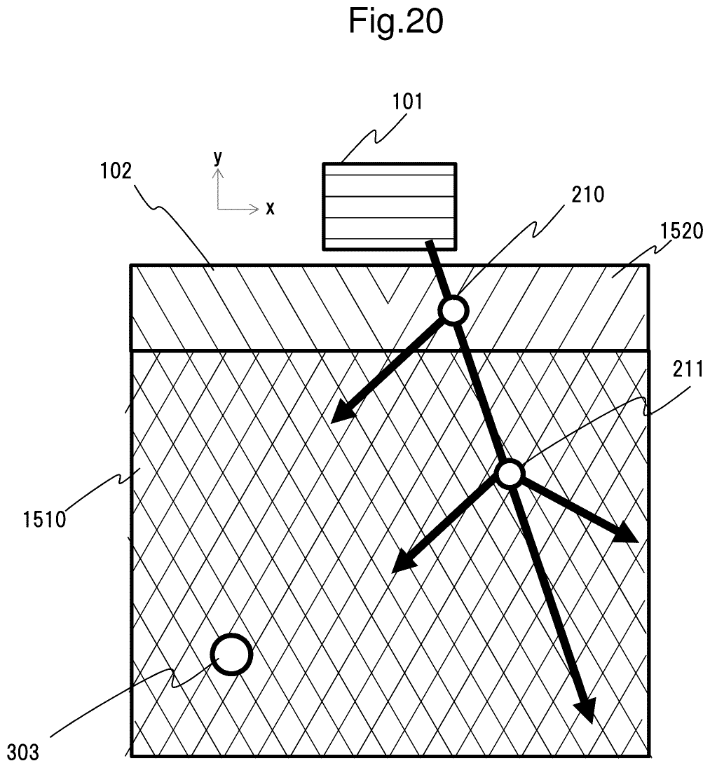

FIG. 19A is a schematic view of the light guiding plate of the embodiment, and describes a central portion 1900 of the line region 1520.

FIG. 19B is an enlarged view of the central portion 1900 and is a schematic view of an ideal case. The figure illustrates that a pattern symmetrical with respect to the center line 1502 is formed. When a pattern is formed using an electron beam lithography method, etc., the region is divided to perform lithography a plurality of times. Thus, two line patterns may be formed out of phase.

FIG. 19C schematically illustrates the case where two line patterns are formed out of phase. In this case, an image light ray reaching a center of the two line patterns is subjected to high-order diffraction combining two line patterns having different phases, and cannot be diffracted in a direction of a predetermined diffraction angle.

FIG. 19D illustrates the case where a gap of a length δ is provided at a boundary of the two line patterns in order to solve this problem. A value of δ is 10 times or more greater than a wavelength 400 to 700 nm of the image light ray. When the value is about 10 μm or more, it is possible to prevent one photon from undergoing composite diffraction across both regions. In addition, assuming that a beam diameter of the image light ray is about 5 mm, when a width of the gap is about 10% of the beam diameter, that is, 500 μm or less, the quantity of light that passes through the gap and is not diffracted can be sufficiently reduced. Therefore, when a pattern is formed with a gap, a size of the gap is preferably in a range of 10 to 500 μm.

The gap provided in the line region 1520 has been described here. However, a similar gap can be provided between the line region 1520 and the mesh region 1510.

### Fourth Embodiment

FIG. 20 is a schematic view for describing a diffraction direction of the diffraction grating of the embodiment. As described with reference to FIG. 6, the image light ray is not visually recognized unless the image light ray reaches the emission circle 303 after being diffracted by the incidence diffraction grating 101. When one image light ray is diffracted at a diffraction point 211 of the mesh region 1510 of the emission diffraction grating 102, as described above, the mesh region has two wavenumbers, and thus there are two cases of diffraction in a direction of the emission circle and diffraction in the opposite direction.

Meanwhile, when the image light ray is diffracted at a diffraction point 210 of the line region 1520, the line region has only one wavenumber, and thus diffraction occurs only in the direction of the emission circle 303, and diffraction in the opposite direction does not occur. Therefore, it can be understood that, by providing the line region, it is possible to reduce the quantity of light that is diffracted in the direction opposite to the emission circle and is not visually recognized by the user, thereby providing the user with a bright projected image.

### Fifth Embodiment

In the above-described embodiment, since the mesh-like emission diffraction grating 102 is formed by superimposing rectangular diffraction gratings of ±60 degrees with respect to the x-axis, an intersection angle between the pitch of the emission diffraction grating 102 and the incidence diffraction grating 101 is 120 degrees. The case where the intersection angle of the emission diffraction grating is 120 degrees or more has been examined. When the intersection angle between the pitch of the emission diffraction grating and the pitch of the incidence diffraction grating is set to 132 degrees, since the angular shift amount of the emission light ray with respect to the incident light ray depends on the wavelength, projecting a color image results in a color-shifted projected image. When a single-wavelength laser light source is used, this can be corrected. However, when an LED (Light Emitting Diode) is used as the light source, it becomes difficult to correct the color shift. Therefore, it is preferable that the intersection angle between the emission diffraction grating and the incidence diffraction grating is 130 degrees or less, preferably 120 degrees or less.

### Sixth Embodiment

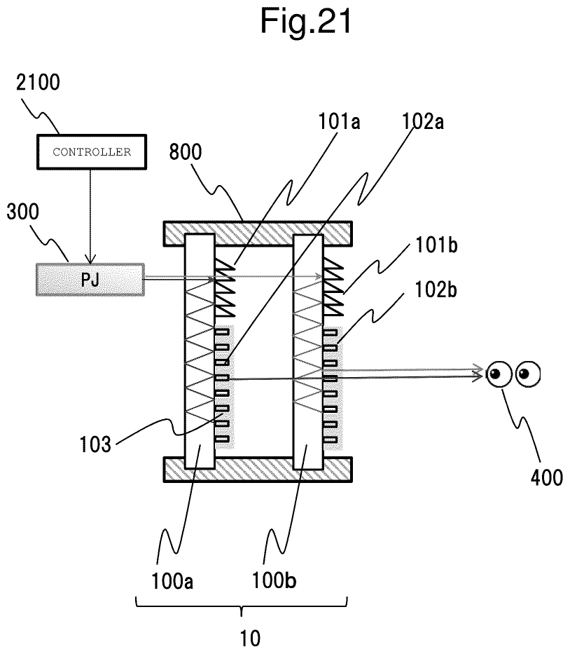

FIG. 21 is a schematic view illustrating a configuration of the image display device of the present embodiment. Light having image information emitted from the projector 300 in the figure is delivered to the pupil 400 of the user by the action of the light guiding plates 100a and 100b, thereby realizing augmented reality. In each of the light guiding plates 100a and 100b, the pitch and depth of diffraction gratings formed are optimized for each color.

In addition, in order to suppress luminance variations due to manufacturing variations for each light guiding plate 100, the regions of the reflective coating described with reference to FIGS. 16A to 16C can be optimized for each light guiding plate. In this case, a reflective coating is applied onto the incidence diffraction grating and to at least a part of the line region, and a region covered by the reflective coating is not the same for each light guiding plate in some cases.

In the figure, the image display device of the present embodiment includes the light guiding plate 100, the projector 300, and a display image controller 2100. In addition, as an image formation method, for example, it is possible to use a widely known image forming apparatus such as an image forming apparatus including a reflection-type or transmission type spatial light modulator, a light source, and a lens, an image forming apparatus using organic and inorganic EL (Electro Luminescence) element arrays and lenses, an image forming apparatus using a light-emitting diode array and a lens, or an image forming apparatus that combines a light source, a semiconductor MEMS (Micro Electro Mechanical Systems) mirror array, and a lens.

In addition, it is possible to use an apparatus in which an LED, a laser light source, and a tip of an optical fiber are resonated by MEMS technology, a PZT (Piezoelectric Transducer), etc. Among these apparatuses, the most common apparatus is the image forming apparatus including the reflection-type or transmission type spatial light modulator, the light source, and the lens. Here, examples of the spatial light modulator may include a transmission-type or reflection-type liquid crystal display such as an LCOS (Liquid Crystal On Silicon) and a digital micromirror device (DMD). Further, as the light source, it is possible to use a white light source separated into RGB, or to use an LED or a laser corresponding to each color.

Furthermore, the reflection-type spatial light modulator may include a liquid crystal display device, and a polarizing beam splitter that reflects a part of light from the light source, guides the part to the liquid crystal display device, transmits a part of light reflected by the liquid crystal display device, and guides the part to a collimating optical system using a lens. Examples of a light-emitting element included in the light source may include a red light-emitting element, a green light-emitting element, a blue light-emitting element, and a while light-emitting element. The number of pixels may be determined based on the specifications required for the image display device. Examples of a specific value of the number of pixels may include 320×240, 432×240, 640×480, 1024×768, and 1920×1080 in addition to 1280×720 shown above. The image display device of the present embodiment is positioned so that a light ray including image information emitted from the projector 300 is applied to each incidence diffraction grating 101 of the light guiding plate 100, and is formed to be integrated with the light guiding plate 100.

In addition, a display image controller (not illustrated) has a function of providing image information to the pupil 400 of the user as appropriate by controlling an operation of the projector 300.

In the above-described embodiments, in a light guiding plate (image display element) having a surface concave-convex type diffraction grating, a mesh-type diffraction grating is used at least as an emission diffraction grating, and is integrally molded using a material having the same refractive index as that of a waveguide by the injection molding method, etc., so that it is possible to realize a plastic light guiding plate, and realize a safe and lightweight light guiding plate. In other words, by using a mesh-type diffraction grating, it is possible to produce a light guiding plate having excellent performance with surface concavities and convexities having an aspect ratio of 1 or less by an injection molding method, etc., and to improve safety and reduce weight by using plastic for the light guiding plate.

In the present embodiment, the case of providing image information to the user has been illustrated. However, the image display device of the present embodiment may additionally include various sensors such as a touch sensor, a temperature sensor, and an acceleration sensor for acquiring information on the user and the external world, and an eye tracking mechanism for measuring movement of eyes of the user.

### REFERENCE SIGNS LIST

100 Light guiding plate
101 Incidence diffraction grating
102 Emission diffraction grating
1510 Mesh region
1520 Line region

1.-15. (canceled)

16. A light guiding plate comprising:
a plastic substrate;
an incidence diffraction grating configured to diffract incident light; and
an emission diffraction grating configured to emit light diffracted by the incidence diffraction grating from the substrate, wherein:
the emission diffraction grating includes a mesh-like grating pattern formed on the substrate;
the mesh-like grating pattern includes a first parallel straight line group and a second parallel straight line group intersecting the first parallel straight line group, and a pitch of the first parallel straight line group is equal to a pitch of the second parallel straight line group;
a line region including only the first parallel straight line group or the second parallel straight line group is provided between the incidence diffraction grating and the mesh-like grating pattern; and
a reflective coating is applied onto the incidence diffraction grating, and a reflective coating is applied to at least a part of the line region.

17. The light guiding plate according to claim 16, wherein:
the substrate is made of a material including a polymer compound;
the mesh-like grating pattern is a concave-convex pattern; and
an aspect ratio of the concave-convex pattern is 1 or less.

18. The light guiding plate according to claim 16, wherein the reflective coating is configured in a continuous region.

19. The light guiding plate according to claim 16, wherein the pitch of the first parallel straight line group, the pitch of the second parallel straight line group, and a pitch of the incidence diffraction grating are equal to one another.

20. The light guiding plate according to claim 16, wherein the incidence diffraction grating is a reflection-type diffraction grating allowing incident light to be reflected and diffracted and to propagate inside the substrate, and is formed on the same surface of the substrate as a surface of the emission diffraction grating.

21. The light guiding plate according to claim 16, wherein the line region includes a first part having only the first parallel straight line group and a second part having only the second parallel straight line group.

22. The light guiding plate according to claim 21, wherein the first parallel straight line group or an extension line thereof and the second parallel straight line group or an extension line thereof form a substantially V-shape when the incidence diffraction grating is on top.

23. The light guiding plate according to claim 21, wherein a gap is provided between the first part and the second part.

24. The light guiding plate according to claim 23, wherein a length of the gap is 10 times or more greater than a wavelength of the incident light.

25. The light guiding plate according to claim 16, wherein a length of the line region is greater than or equal to a thickness of the light guiding plate and less than or equal to a length of a region of the mesh-like grating pattern.

26. A light guiding plate module configured by stacking a plurality of light guiding plates, each of which is the light guiding plate according to claim 16.

27. The light guiding plate module according to claim 26, wherein, in each of the plurality of light guiding plates, a region covered by the reflective coating is not the same for each light guiding plate.

28. An image display device comprising:
the light guiding plate module according to claim 26; and
a projector configured to apply image light to the light guiding plate module, wherein the image light is incident on the incidence diffraction grating.

29. The image display device according to claim 28, wherein the light guiding plate module emits the image light to an opposite side from a side where the projector is disposed.
